(19) United States
(12) Patent Application Publication
(10) Pub. No.: US 2012/0104836 A1
(43) Pub. Date: May 3, 2012

(54) STRUCTURE OF FAST-SCREWED TWO-PIECE TYPE WHEEL RIM

(76) Inventor: Ho-Yo LIAO, Dacun Township (TW)

(21) Appl. No.: 12/916,548

(22) Filed: Oct. 31, 2010

(51) Int. Cl. B60B 3/00

(52) U.S. Cl. 301/64.301

(57) ABSTRACT

The present invention provides a structure of fast-screwed two-piece type wheel rim, mainly comprises an inner half wheel rim and an outer half wheel rim both being installed with protruding skeletons at the outer ends and formed with a through hole in the center, the inner end of the inner half wheel rim is installed with a cylindrical protruding member having outer thread, an expansion protruding ring having an annular concave slot is installed at a base portion of the cylindrical protruding member for being installed with a seal unit, the inner end of the outer half thread. As such, the inner and outer half wheel rims can be respectively installed from two side of a tire for being directly integrally airtight combined by a positioning screw screwed through the positioning hole and installed the seal unit installed between the inner and outer half wheel rims.

### BACKGROUND OF THE INVENTION

1. Field of the Invention

The present invention relates to a structure of fast-screwed two-piece type wheel rim, particularly to a design of two-piece type wheel rim of small tire suitably to be used in an electrical walk-assisting vehicle or an electrical vehicle for disabled people. The structural design of the mentioned fast-screwed two-piece type wheel rim is able to simplify the processing procedure, use less materials and easy to assemble/disassemble, and capable of being used in a tubeless tire.

2. Description of Related Art

For a vehicle adopting small tires such as electric walk-assisting vehicle for elder people or electrical vehicle for disabled people, the wheel, rim design for said tire mostly adopts a two-piece type wheel rim and a plurality of screws for screwing and assembling. The mentioned two-piece type wheel rim is used in both of a tube type tire or foam filled tire, the operation and assembly means are illustrated as followings:

As shown in FIG. 1, which is a schematic structural view of a conventional two-piece type wheel rim being adopted in a foam filled tire (A1); two wheel rims (A4) (A5) thereof are screwed and fixed on screws protrudingly installed on a hub (A3) through a plurality of screw nuts (A2), so the two wheel rims (A4) (A5) are clamped and fastened at two sides of the foam filled tire (A1); as shown in FIG. 2, which is a schematic structural view of a conventional two-piece type wheel rim being adopted in a tire (B1) having an inner tube (B2), two wheel rims (B5) (B6) thereof are screwed and fixed on screws protrudingly installed on a hub (B4) through a plurality of screw nuts (B3) so the two wheel rims (B5) (B6) are clamped and fastened at two sides of the tube type tire (B1); in the mentioned assembly means of the two-piece type wheel rim, two wheel rims have to be respectively installed and positioned from two sides of a tire, and preset holes thereof have to be aligned, then a hub is installed at the inner wheel rim and screws protrudingly installed on the hub penetrate through holes formed on the two wheel rims, lastly screw nuts are provided to be screwed with the screws on the hub at the outer wheel rim, so the whole assembly operation is complicated and time consuming, and the assembly/disassembly of screw nuts has to be performed with a wrench tool, thus the mentioned operation can not really be seen as an ideal operation.

Moreover, for the tube type tire, there are concerns of being stabbed by nails which causes the gas inside the tire being leaked, and inconvenience and danger of stopping the vehicle in the middle of the road are also occurred; as for the foam filled tire, there are disadvantages of consuming more materials, higher cost in production, adding more load to the vehicle, shortening service life and drive miles of the vehicle, and the foam filled tire lacks elasticity so less comfort can be provided while driving, thus the mentioned tires are gradually replaced by the tubeless tire.

As shown in FIG. 3, the mentioned two wheel rims (C5) (C6) are adopted in a tubeless tire (C1), a plurality of screw nuts (C2) are utilized to be screwed with screws protrudingly installed on a hub (C3), and an O-shaped ring (C4) for preventing gas leaking is further installed between the two wheel rims (C5) (C6), so the two wheel rims (C5) (C6) are clamped and fixed at two sides of the tubeless tire (C1), and an airtight effect is obtained. But said assembly means is still complicated and time consuming, and a wrench tool is still needed to be provided. As such, a solution is as shown in FIG. 4, a single-piece type wheel rim (D2) is adopted in a tubeless tire (D1), and no screw operation is needed, so the structure is relatively simple, but the disadvantage is that the assembly of the wheel rim and the tire has to be performed by a special tool, especially for the tires used in the electric walk-assisting vehicle and electric vehicle for disabled people, the tires are small having smaller wheel diameters, moreover the vehicles are mostly used by elder or disabled people, so a tire installing tool specially designed to be manually operated is hard to be used for assembling or disassembling, and no doubt that a conventional electric tire installing machine for larger tires used in a car or motorbike can not be used in the assembly or disassembly of small tubeless tires.

In other words, a combination means of small tubeless tire and single-piece wheel rim has some assembly issues, and generally can not be performed by a user, and in a general car repair workshop without an electric tool, the assembly is still hard to be performed, such that the vehicle has to be transported to a repair shop with electric tools or to the original factory for maintenances, this will cause higher maintenance fee and financial expenditure, and is also time consuming, so a single-piece type wheel rim adopted in a small tubeless tire used in electric walk-assisting vehicle or electric vehicle for disabled people is yet to be seen in the market.

### SUMMARY OF THE INVENTION

The problem to be solved by the present invention is to overcome problems that small tires used in an electric walk-assisting vehicle or electric vehicle for disabled people have to utilize plural screw nuts for being fastened with screws installed on a hub so as to screw and listen the two-piece type wheel rim, and can only be used in a tube-type tire or foam filled tire which may cause waste of material and danger while driving. So the present invention is aimed to improve the design of the assembly structure of the two-piece type wheel rim, such that the assembly can be simplified and faster and an object of airtight can be achieved, thus can also be adopted in a more-advanced tubeless tire.

The solution provided by the present invention for the structure of two-piece type wheel rim characterizes in that tire bead seats capable of being tightly sealed with the tire bead of a tire are installed on the two-piece type wheel rim with a forging casting means, and inner ends of the two wheel rims are respectively installed with a cylindrical protruding member having outer thread and an annular protruding member having inner thread, meanwhile outer ends of the two wheel rims are installed with a plurality of protruding skeletons allowing a user's hands to perform operations of holding and rotating, such that the two wheel rims can be respectively installed from two sides of the tire and be processed with a screwing operation so as to be integrally combined, and a positioning screw is provided for penetrating and being screwed in corresponding preset positioning holes of the two wheel rims, so the two wheel rims are fixed and not rotatable through the screw locking operation of the positioning screw. As such, the assembly relationship between the two wheel rims and the tire is stabled and ensured, and an object of providing an airtight elect between the wheel rims and the tire is achieved through pre-installing an O-shaped ring, anti-leaking belt or anti-loosening (NYLOK) adhesive at an interface defined by the two wheel rims, so is capable of being adopted in a tubeless tire; and during the whole disassembly operation, the protruding skeletons installed at the outer ends of the wheel rims allowing hands to hold and apply forces, so there is no need of a specially-designed tool or machine, an easier and more convenient disassembly operation is therefore provided compared to conventional structures.

### BRIEF DESCRIPTION OF THE DRAWINGS

FIG. 1 is a schematic structural view of a conventional two-piece type wheel rim being adopted in a foam filled tire;

FIG. 2 is a schematic structural view of a conventional two-piece type wheel rim being adopted in a tube-type tire;

FIG. 3 is a schematic structural view of a conventional two-piece type wheel rim being installed with an O-shaped ring and being adopted in a tubeless tire;

FIG. 4 is a schematic structural view of a single-piece type wheel rim being adopted in a tubeless tire;

FIG. 5 is a schematic view illustrating the manufacturing procedure and structure of the inner half wheel rim of one preferred embodiment of the present invention;

FIG. 6 is a schematic structural view of the inner half wheel rim of one preferred embodiment of the present invention, being viewed from various directions;

FIG. 7 is a schematic view illustrating the manufacturing procedure and structure of the outer half wheel rim of one preferred embodiment of the present invention:

FIG. 8 is a schematic structural view of the outer half wheel rim of one preferred embodiment of the present invention, being viewed from various directions;

FIG. 9 is a schematic view illustrating the whole assembly and operation of one preferred embodiment of the present invention;

FIG. 10 is a schematic structural view illustrating the present invention being served in a driving wheel; and

FIG. 11 is a schematic structural view illustrating the present invention being served in a passive wheel.

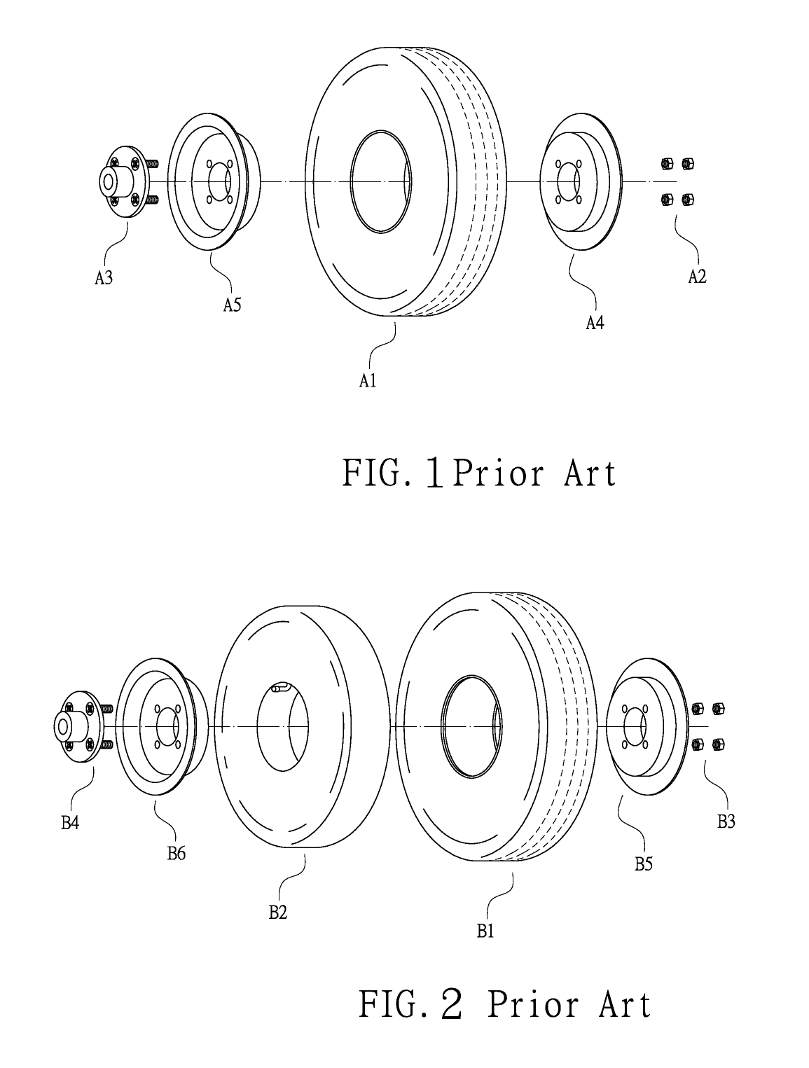

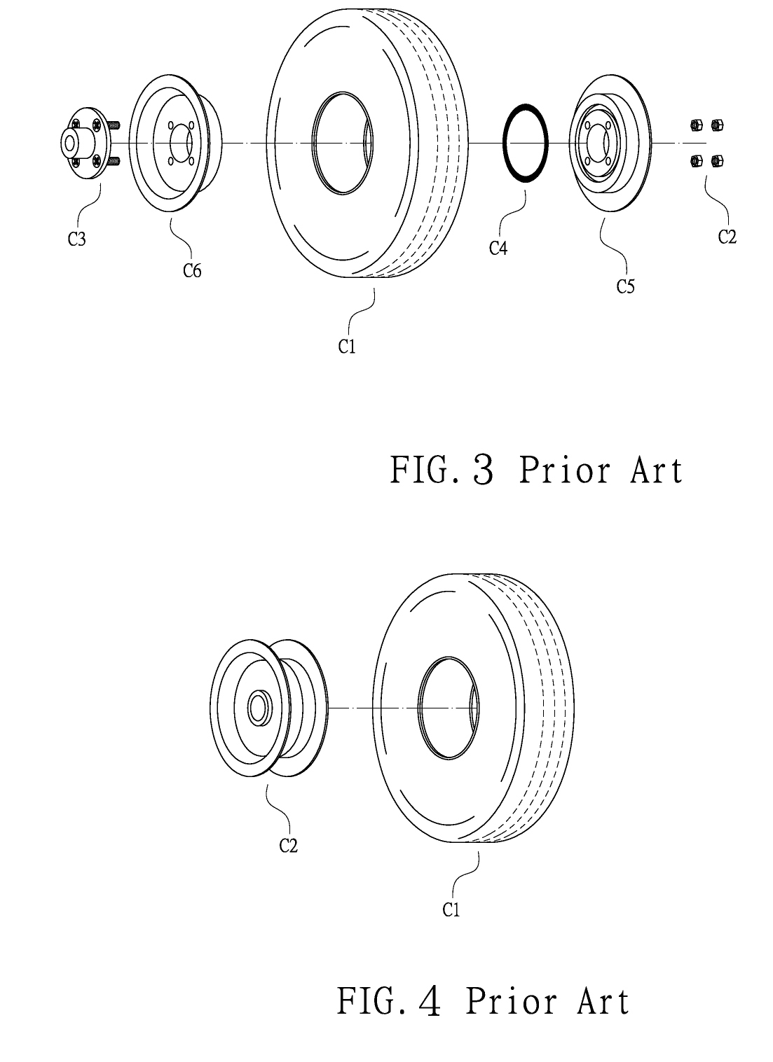

### DESCRIPTION OF MAIN COMPONENT SYMBOLS

(1) inner half wheel rim
(11) outer ring sheet
(111) tire bead seat
(112) protruding skeleton
(12) cylindrical protruding member
(121) outer thread
(13) central through hole
(131) bearing
(14) expansion protruding ring
(15) annular concave slot
(16) ring surface
(17) positioning hole
(2) outer half wheel rim
(21) outer ring sheet
(211) tire head seat
(212) protruding skeleton
(213) gas valve hole
(22) annular protruding member
(221) inner thread
(23) central through hole
(24) ring surface
(25) positioning hole
(3) O-shaped ring
(4) tire
(5) positioning screw
(6) transmission shaft
(7) pin

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

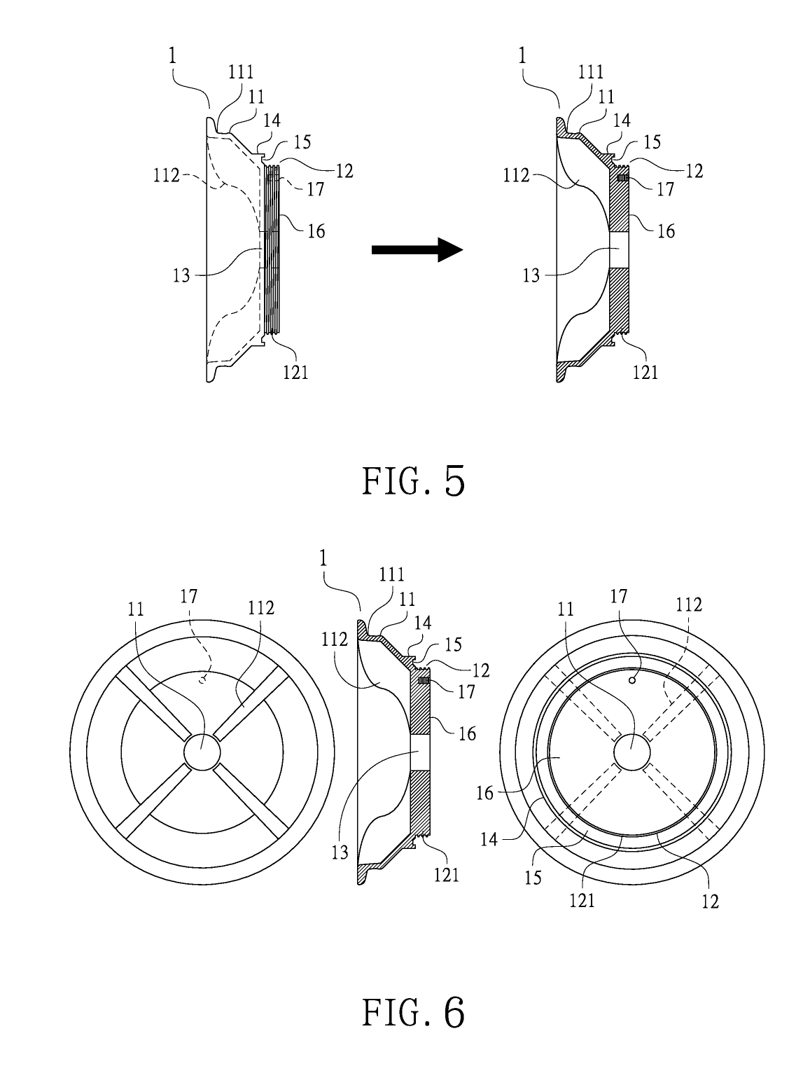

Referring to FIG. 5 and FIG. 6, which illustrate the structure of inner half wheel rim of the present invention, in which a blank member of the inner half wheel rim (1) is made of a metal material with a forging means or a casting means (hereinafter referred as a forging casting means), and mainly includes an outer ring sheet (11) installed at the outer end and a cylindrical protruding member (12) having outer thread installed, at the inner end. The height of the cylindrical protruding member (12) is about 24 mm, and the diameter thereof is about 70 mm, and a central through, hole (13) having a diameter of 1.5 mm or even larger is coaxially formed at the center of the cylindrical protruding member (12). The central through hole (13) is served to be connected with a transmission shalt so as to be operated in a driving wheel or to allow a bearing to be installed thereon for installing of a transmission shaft so as to be operated in a passive wheel. The inner edge of the outer ring sheet (11) is installed with a flange and a tire bead seat (111) capable of being tightly sealed with the tire bead of a tire, and a plurality of protruding skeletons (112) allowing to be held by hands and be applied with torque are installed between the outer end of the outer ring sheet (11) and the central through hole (13). An expansion protruding ring (14) having a width and a height both about 1.5 mm is installed at an outer base portion of the cylindrical protruding member (12), and an annular concave slot (15) having a width about 3 mm is formed between the inner ring surface of the expansion protruding ring (14) and the cylindrical protruding member (12), such that a seal unit can be mounted for achieving an airtight effect. The seal unit can be an O-shaped ring, or can be replaced with an anti-leaking belt or anti-loosening (NYLOK) adhesive. And at least one or more than one positioning holes (17) are installed on an inner ring surface (16) of the cylindrical protruding member (12).

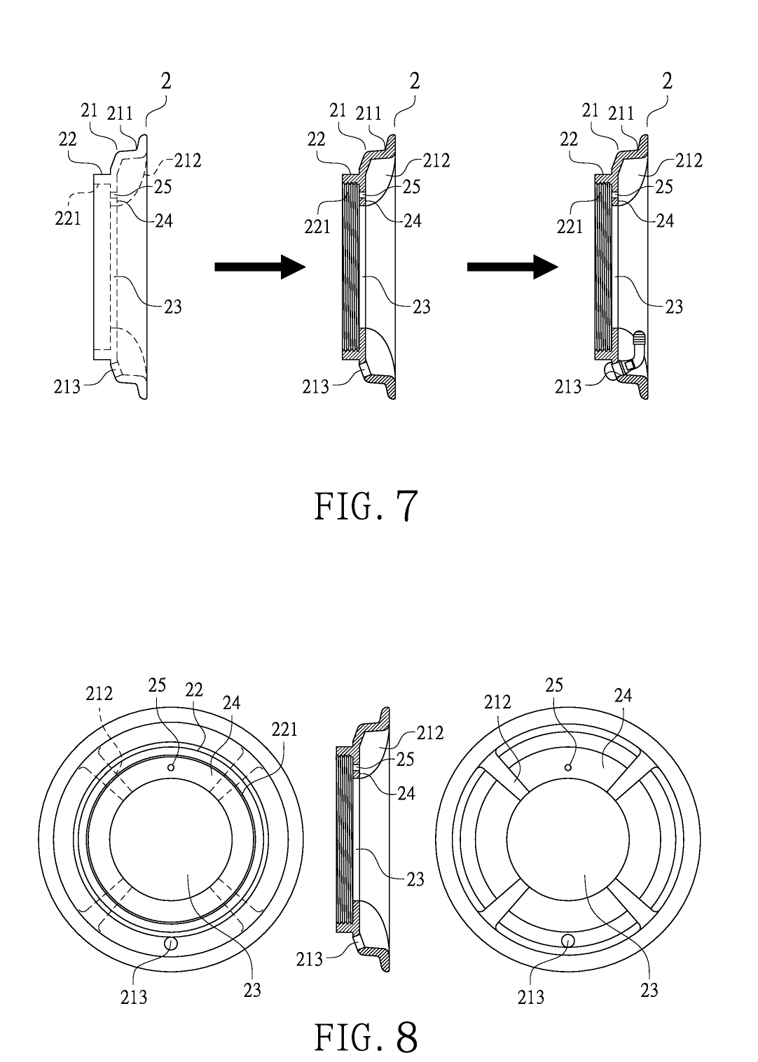

Referring to FIG. 7 and FIG. 8, which illustrate the structure of outer half wheel rim of the present invention, in which a blank member of the outer half wheel rim (2) is made of a metal material with a forging casting means, and mainly includes an outer ring sheet (21) installed at the outer end and an annular protruding member (22) having inner thread installed at the inner end. The inner diameter of the annular protruding member (22) is about 68 mm, the width thereof is about 5 mm and the height thereof is about 27 mm, and a central through hole (23) having a diameter about 40 mm is coaxially formed at the center for allowing the transmission shall to pass through. The inner edge of the outer ring sheet (21) is installed with a flange and a tire bead seat (211) capable of being tightly sealed with the tire bead of a tire, and a plurality of protruding skeletons (212) allowing to be held by hands and be applied with torque are installed between the outer end of the outer ring sheet (21) and the central through hole (23), and a round through hole, serving as a gas vale hole (213), is formed between the tire bead seat (211) and the annular protruding member (22) so an gas valve nozzle can be installed therein. And at least one positioning hole (25) is installed between the inner thread (221) of the annular protruding member (22) and a ring surface (24) of the central through hole (21).

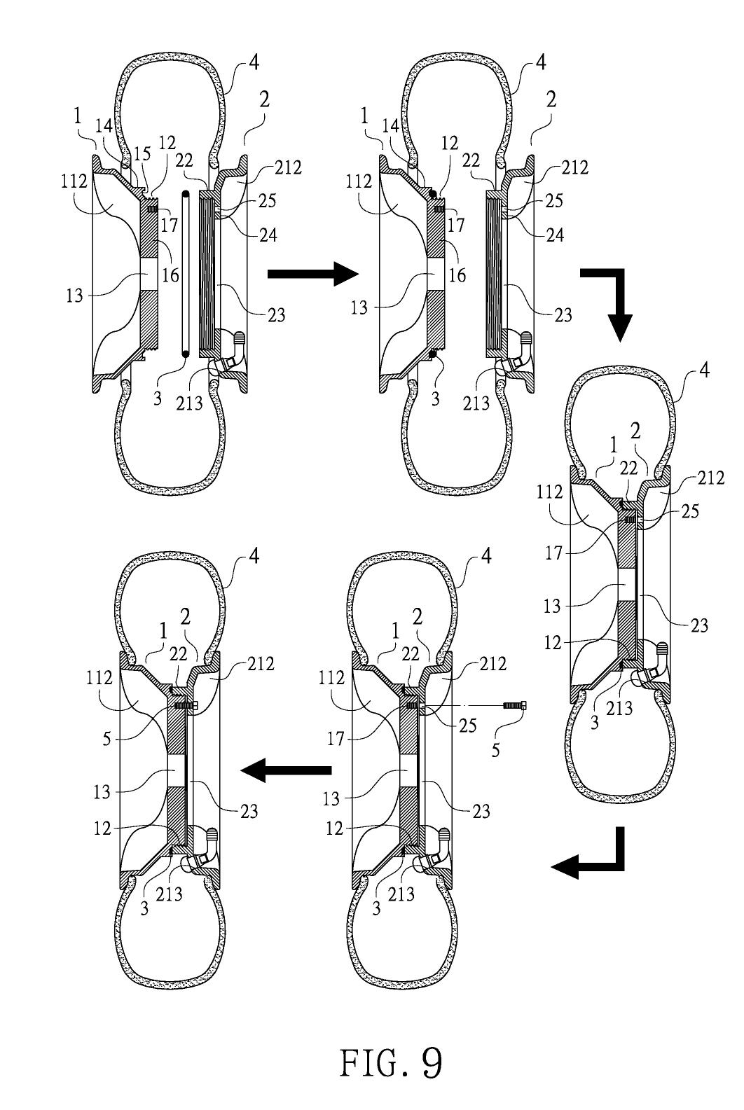

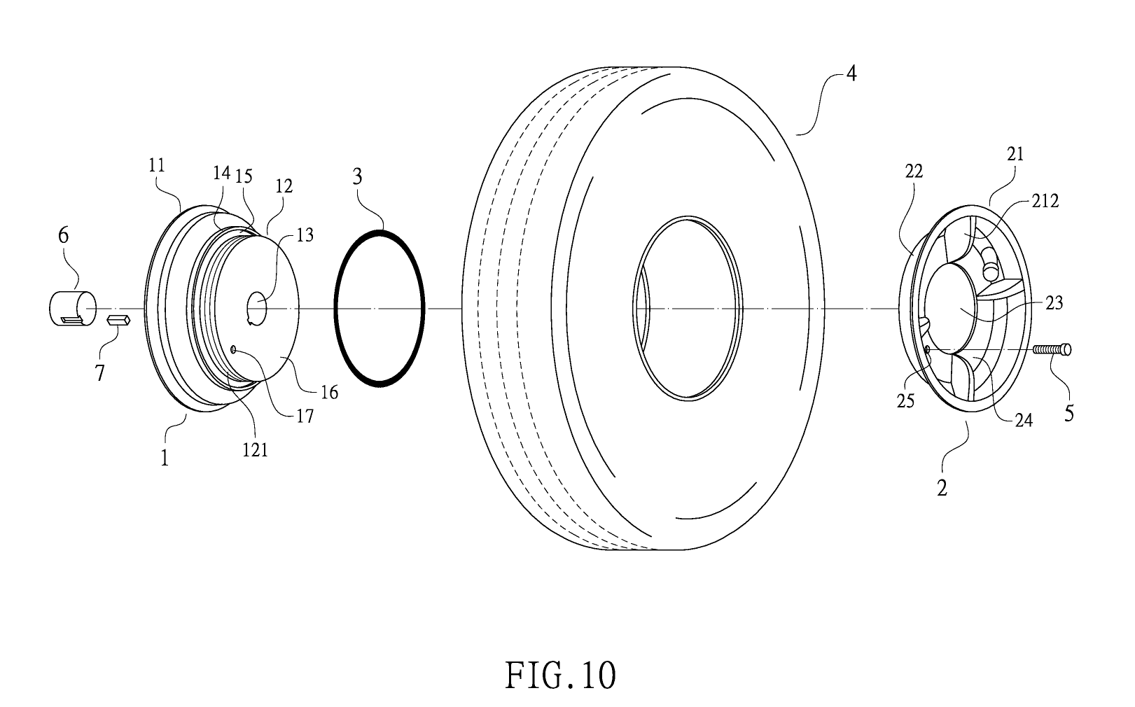

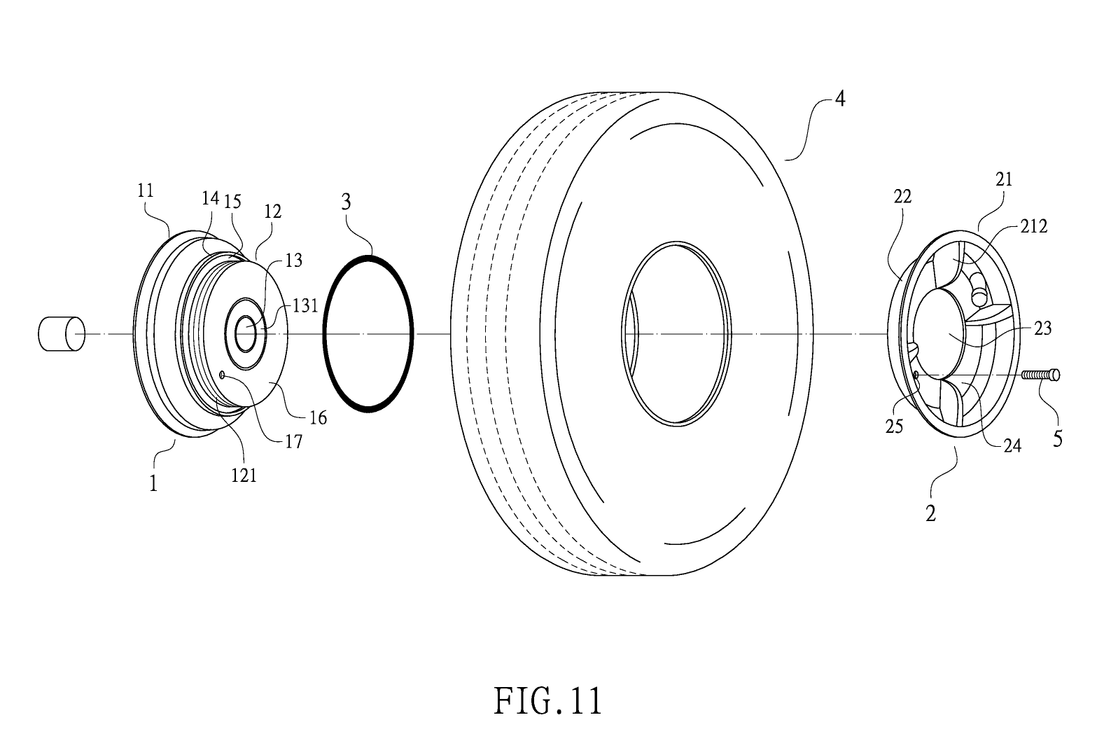

Referring to FIG. 9, FIG. 10 and FIG. 11, and with the mentioned structural design of the inner half wheel rim (1) and the outer half wheel rim (2); when being assembled with a tire (4), an elastic O-shaped ring (3) having an inner diameter of 70 mm and a ring diameter of 3 mm in mounted in the cylindrical protruding member (12) of the inner half wheel rim (1) and the annular concave slot (15) of the expansion protruding ring (14), and the inner half wheel rim (1) and the outer half wheel rim (2) are respectively installed in an inner wheel hole of the tire (4) from two lateral sides of the tire (4), meanwhile the protruding skeletons (112) (212) of the inner and outer wheel rims (1) (2), serving as levers, are held by two hands for applying forces to rotate, such that the outer thread (121) of the cylindrical protruding member (12) of the inner half wheel rim (1) and the inner thread (221) of the annular protruding member (22) of the outer half wheel rim (2) are directly engaged and screwed, and the O-shaped ring (3) mounted in the annular concave slot (15) of the inner half wheel rim (1) is tightened so the airtight effect is obtained; meanwhile, the tire bead of the tire (4) are still tightly sealed in the tire bead seats (111) (211) of the inner and outer half wheel rims (1) (2), lastly a positioning screw (5) is installed from the positioning hole (25) of the ring surface (24) of the outer half wheel rim (2) to the corresponding positioning hole (17) of the ring surface (16) of the inner half wheel rim (1) so as to be fixed, such that the screwing relationship between the inner and outer half wheel rims (1) (2) is ensured. As such, after being screwed, the inner half wheel rim (1) and the outer half wheel rim (2) are effectively prevented from being loosened, so the assembly of the two wheel rims can be rapidly screwed and finished, and also suitable to be adopted in a tubeless tire.

In view of different functions provided by driving wheels and passive wheels used in an electric walk-assisting vehicle or electric vehicle for disabled people, the present invention utilizes a design of varying the aperture of the central through hole (13) of the inner half wheel rim (1) for meeting the specifications of driving wheels or passive wheels; when the diameter of the central through hole (13) of the inner half wheel rim (1) is 15 mm, a pin (7) can be provided for being directly connected with the transmission shaft (6) so as to be served as a driving wheel, referring to FIG. 10, which is a schematic view of the assembly of the driving wheel; when the diameter of the central through hole (13) of the inner half wheel rim (1) is expanded to 31.94 mm, two ends thereof installed with a hearing (131) having an outer diameter of 32 mm and an aperture of 15 mm, and is connected with the transmission shaft (6) so as to be served as a passive wheel, referring to FIG. 11, which is a schematic view of the assembly of the passive wheel.

The structural design of the structure of fast-screwed two-piece type wheel rim of the present invention can achieve the following effects:
(1) Reducing consumptions of materials and energy: because the two-piece type wheel
(2) Enhancing driving safety: because the present invention can utilize a tubeless tire which gradually and slowly leaks gas when being stabbed by external matters, the vehicle can still be driven to a safe location or a maintenance station, thus the problem of the tube-type tire of rapidly leaking gas when being stabbed by external matters and the vehicle has to be stopped in a rush, which may cause inconvenience and danger, so for elder or disabled people, the present invention provide them with a better safety performance;
(3) Rapid and convenient assembly/disassembly: the two-piece type wheel rim of the present invention utilizes inner and outer threads correspondingly being directly engaged and screwed, and only a screw is needed for fastened, meanwhile the wheel rim can be directly connected with the transmission shaft without the installation of a hub that is required by a conventional two-piece type wheel rim for being connected with a transmission shaft, so the material cost is saved, and the assembly/disassembly procedure is also simplified, an easier and rapid assembly/disassembly operation is provided, such that even a vehicle user can assemble/disassemble the wheel rim or repair the tire by himself with simple tools, so maintenance cost is saved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A structure of screwed two-piece type wheel rim, mainly comprises: an inner half wheel rim and an outer half wheel rim, centers of the inner and outer half wheel rims are both formed with a central through hole capable of being connected with a transmission shaft, and inner ends of outer ring sheets thereof are both installed with a coaxial flange and a tire bead seat capable of being tightly sealed with the tire bead of a tire, and outer ends of the outer ring sheets are both installed with protruding skeletons allowing to be rotated, a cylindrical protruding member having outer thread is installed at the inner end of the inner half wheel rim, and an expansion protruding ring provided with an annular concave slot is installed at a base portion of the cylindrical protruding member for being installed with a seal unit, an annular protruding member having inner thread is installed at the inner end of the outer half wheel rim, the inner thread of the annular protruding member and the outer thread of the cylindrical protruding member are engaged and screwed so as to finish the assembly of the inner and outer half wheel rims.

2. The structure of fast-screwed two-piece type wheel rim as claimed in claim 1, wherein at least one positioning hole is installed on the inner ring surface of the cylindrical protruding member of the inner half wheel rim, and at least one positioning hole is installed on the ring surface between the inner thread of the annular protruding member and the central through hole of the outer half wheel rim, and a positioning screw is provided for passing through the positioning holes of the inner and outer half wheel rims so as to fasten the inner and outer half wheel rims.

3. The structure of fast-screwed two-piece type wheel rim as claimed in claim 1, wherein the aperture of the central through hole of the inner half wheel rim is variable.

4. The structure of fast-screwed two-piece type wheel rim as claimed in claim 1, wherein the seal unit between the inner and outer half wheel rims is an O-shaped ring.

5. The structure of fast-screwed two-piece type wheel rim as claimed in claim 1, wherein the seal unit between the inner and outer half wheel rims is an anti-leaking belt.

6. The structure of fast-screwed two-piece type wheel rim as claimed in claim 1, wherein the seal unit between the inner and outer half wheel rims is an anti-loosening (NYLOK) adhesive.
